(19) United States
(12) Patent Application Publication
(10) Pub. No.: US 2017/0180445 A1
(43) Pub. Date: Jun. 22, 2017

(54) ADVERTISEMENT DATA ACQUISITION METHOD AND ELECTRONIC EQUIPMENT

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo Ao, Beijing (CN)

(21) Appl. No.: 15/240,845

(22) Filed: Aug. 18, 2016

Related U.S. Application Data
(63) Continuation of application No. PCT/CN2016/088937, filed on Jul. 6, 2016.

(30) Foreign Application Priority Data
Dec. 22, 2015 (CN) 201510971044.3

(51) Int. Cl. H04L 29/06; G06Q 30/02; H04L 29/08

(52) U.S. Cl. CPC H04L 65/602; H04L 67/06; G06Q 30/0277; H04N 21/812

(57) ABSTRACT

A method for obtaining advertisement data is provided according to the present disclosure, which includes: reading program data in a live file; sending request information for obtaining the advertisement data to an advertisement server, when an advertisement identification preset in the program data is read; receiving the advertisement data sent by the advertisement server in response to the request information; and writing the advertisement data to a position indicated by the advertisement identification in the live file. An electronic device for obtaining advertisement data is further provided according to the present disclosure.

### CROSS-REFERENCE TO RELATED APPLICATIONS

This application is a continuation of International PCT Patent Application No. PCT/CN2016/088937, filed Jul. 6, 2016 (attached hereto as an Appendix), and claims benefit/priority of Chinese patent application entitled “ADVERTISEMENT DATA ACQUISITION METHOD AND ELECTRONIC EQUIPMENT”, application number 201510971044.3, filed with the State Intellectual Property Office of China on Dec. 22, 2015, which are all incorporated herein by reference in entirety.

### TECHNICAL FIELD

The present disclosure relates to the field of multimedia information playing, and in particular, to a method and electronic device for obtaining advertisement data.

### BACKGROUND

With the development of technology, playing modes for audio and video files become more various, and at present, a live mode based on the streaming media protocol is one of the most widely used playing modes.

Generally, before the audio and video files are played based on the streaming media protocol, program data is listed by a live server in a preset time sequence, and thus live files of a program list are generated in a fixed order. Based on the characteristics of the live files being prelisted, in order to play advertisement during playing the live files, the advertisement data is generally arranged into the program data as data of the live files, when the program data is listed by the live server. Hence, advertisements may be played normally during playing the live files.

As can be seen from the above related art, since the advertisement data is pre-arranged into the program data in the live files, the pre-arranged advertisements are played whenever the live files are played, with waste of advertising resources and poor user experience.

### SUMMARY

In view of above, a method and electronic device for obtaining advertisement data are provided according to the present disclosure, so as to solve the problem that advertisements being pre-arranged in the live files cause waste of advertising resources and poor user experience.

In a first aspect, a method for obtaining advertisement data is provided according to an embodiment of the present disclosure, which includes: reading program data in a live file; sending request information for obtaining the advertisement data to an advertisement server, when an advertisement identification preset in the program data is read; receiving the advertisement data sent by the advertisement server in response to the request information; and writing the advertisement data to a position indicated by the advertisement identification in the live file.

In a second aspect, a non-volatile computer storage medium stored with computer executable instructions is further provided according to an embodiment of the present disclosure, wherein the computer executable instructions are set to perform any one of the above methods for obtaining advertisement data in the first aspect of the present disclosure.

In a third aspect, an electronic device is further provided according to an embodiment of the present disclosure, including at least one processor and a memory communicably connected with the at least one processor and storing instructions executable by the at least one processor, wherein execution of the instructions by the at least one processor causes the at least one processor to perform any one of the above methods for obtaining advertisement data in the first aspect of the present disclosure.

It is to be understood that both the foregoing general description and the following detailed description are exemplary and explanatory only, and are not restrictive of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for obtaining advertisement data according to an embodiment of the present disclosure;

FIG. 2 is a flow chart of a second implementation of a method for obtaining advertisement data according to an embodiment of the present disclosure;

FIG. 3 is a schematic structural diagram of a device for obtaining advertisement data according to an embodiment of the present disclosure;

FIG. 4 is a schematic structural diagram of a second implementation of a device for obtaining advertisement data according to an embodiment of the present disclosure;

FIG. 5 is a schematic structural diagram of a system for obtaining advertisement data according to an embodiment of the present disclosure; and

FIG. 6 is a hardware structure diagram of an electronic device for performing a method for obtaining advertisement data according to an embodiment of the present disclosure.

### DETAILED DESCRIPTION

The technical solutions in the embodiments of the present disclosure will be described clearly and fully below in conjunction with the drawings in the embodiments of the present disclosure. Apparently, the embodiments described are only a part of the embodiments of the present disclosure, rather than being the whole embodiments. All of the other embodiments obtained by one of ordinary skills in the art based on the embodiments of the present disclosure without creative work pertain to the protection scope of the present disclosure.

In the technical solutions of the embodiments of the present disclosure, advertisement data is obtained by a client terminal when the live file is played in a real time manner. The technical solution is described from a perspective of a client terminal below, in order that those skilled in the art may understand the technical solution more accurately.

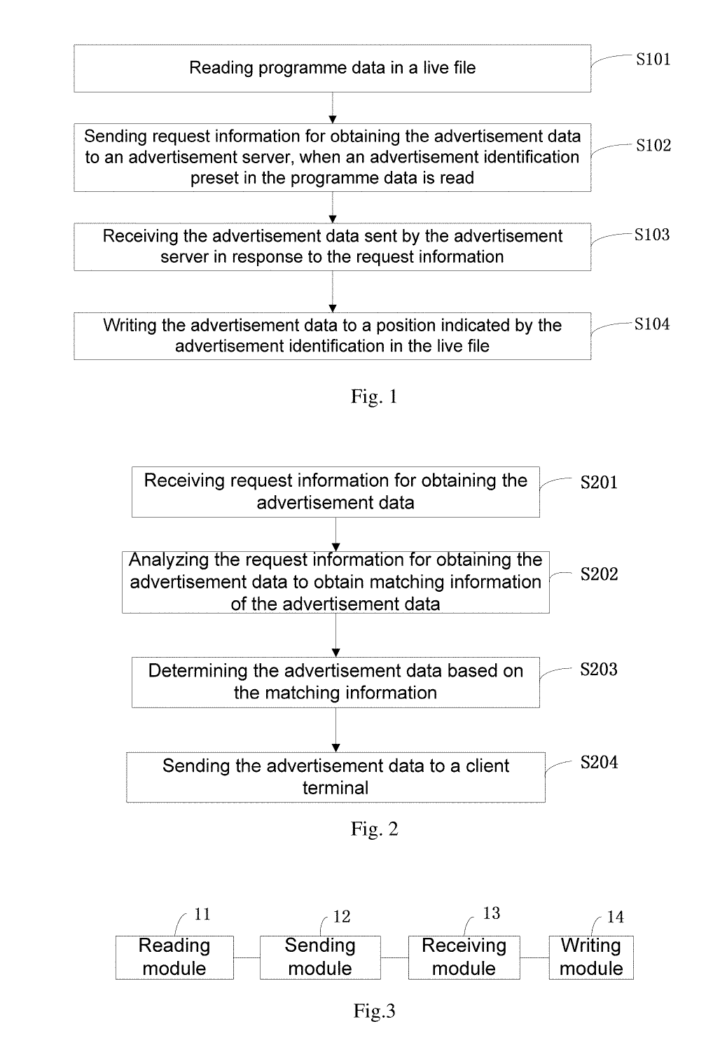

Referring to FIG. 1, it shows a flow chart of a method for obtaining advertisement data according to an embodiment of the present disclosure. The method includes the following steps.

In step S101, program data in a live file is read.

In the live mode based on a streaming media protocol, after the live file is listed, the live server stores a data stream of the live file to be pieces of TS streams (Transport Stream), and the client terminal continually reads the TS stream according to the listed order during playing the live file, thereby achieving live broadcast. The TS stream may be stored to be a file in a format of .m3u, each piece of the TS streams may be a data segment with a duration of 10 seconds. Of course, each piece of the TS streams may also be a data segment with another duration, which is not limited in the embodiments of the present disclosure.

It should be noted that, since the advertisement data is obtained by the client terminal in a real time manner from the advertisement server when the technical solution is implemented, no advertisement data is set in the live file, and the obtained advertisement data is inserted into the live file after the advertisement data is obtained by the client terminal. Optionally, placeholder data, which may be a piece of public service advertisement data, is set at a position corresponding to the advertisement data, and the advertisement data is used to replace the placeholder data after the advertisement data is obtained by the client terminal. Specifically, reference is made to the following description, which is not described in details herein. Therefore, in this step, only program data in the live file is read by the client terminal.

In step S102, request information for obtaining the advertisement data is sent to an advertisement server, when an advertisement identification preset in the program data is read.

The advertisement data is obtained by the client terminal in a real time manner from the advertisement server, and the data is read by the client terminal in a unit of TS stream. Therefore, the advertisement data may be obtained in advance by the client terminal before the advertisement data is read, in order that the live playing of the advertisement is not interfered. In the embodiment, the advertisement identification is preset in the program data by the live server, and the client terminal sends a request for obtaining the advertisement data to the advertisement server to obtain the advertisement data, when the advertisement identification is read.

It should be noted that the advertisement identification indicates information showing a position of the advertisement data. The position of the advertisement data indicated by the advertisement identification is set behind the advertisement identification, and several pieces of TS streams may be placed between the position of the advertisement data and the advertisement identification to give enough time to obtain the advertisement data. The number of the placed pieces of TS streams may be set adaptively according to requirements, which is not limited in the embodiment of the present disclosure.

Furthermore, in order to improve accuracy of directionally matching advertisement content and to improve user experience, before generating the request information for obtaining the advertisement data, the client terminal may also obtain attribute information of the live file and device information of the client terminal, which are used as index information of the advertisement data to generate request information, so that the advertisement server directionally matches the advertisement data according to the index information.

For example, when a television drama ‘ZhenHuan Biography’ is played currently, the client terminal may send starring performer information of ‘ZhenHuan Biography’ to the advertisement server; optionally, current play record information of the client terminal is sent to the advertisement server, so that the advertisement server determines a gender of the user according to the browsing records.

As can be seen from the description of this step, the advertisement identification is preset in the live file, so that the client terminal may be triggered at appropriate time to obtain the advertisement data, thereby obtaining the advertisement data in a real time manner.

In step S103, the advertisement data sent by the advertisement server in response to the request information is received.

After sending the request information for obtaining the advertisement data, the client terminal receives the advertisement data sent by the advertisement server in response to the request information. It should be noted that, since the transfer of the live file complies with the streaming media protocol, the live file is in a format complying with the streaming media protocol, and the advertisement data is also in a format complying with the streaming media protocol. In an optional embodiment of the present disclosure, the live file and the advertisement data are in a format of .m3u.

Furthermore, in order to improve the accuracy of directionally matching advertisement, the advertisement data received by the client terminal may be associated with the program played currently, or may be popularized advertisement data including programs of similar types. For example, if the currently played program is the ‘ZhenHuan Biography’, the played advertisement may be a popularized advertisement of a television drama with the same production team as that of the ‘ZhenHuan Biography’. Optionally, the played advertisement may also be adapted to user attribute. For example, if the user is female, the advertisement data may be data of advertisements for cosmetics, baby products or the like; if the user is male, the advertisement data may be data of advertisements for razors, cars or the like. The above advertisement data is matched by the advertisement server according to the content of the request information, which is described in detail in the following embodiment.

According to the description of this step, the advertisement data received by the client terminal may be matched with the played program and the user attribute, thereby improving the accuracy of directionally matching advertisement and improving user experience.

In step S104, the advertisement data is written to a position indicated by the advertisement identification in the live file.

As can be seen from the above description, the advertisement identification indicates position information of the advertisement data in the live file. In the embodiment, the position information of the advertisement data may include information of TS streams connected before and after the advertisement data, and the advertisement data is written between two pieces of corresponding TS streams by the client terminal after the advertisement data is received.

It should be noted that, placeholder data may be set at the position corresponding to the advertisement data, and the step is performed in different ways based on whether the placeholder data is set. The executions for the two cases are described respectively below.

In a case that no placeholder data is set at the position corresponding to the advertisement data, the advertisement identification only indicates the TS streams connected before and after the advertisement data. Therefore, the client terminal may determine the adjacent TS stream before the advertisement data according to the position information in the advertisement identification, and the client terminal writes the received advertisement data behind the adjacent TS stream after the adjacent TS stream is read. After all of the advertisement data is written, the client terminal continues to read the TS stream of the program data and then inserts the advertisement data into the live file.

In a case that the placeholder data is set at the position corresponding to the advertisement data, the client terminal may determine the adjacent TS stream according to the indication of the advertisement identification, determine the placeholder data after the adjacent TS stream is read, then delete the placeholder data, and write the received advertisement data into the position corresponding to the placeholder data, thereby replacing the placeholder data with the advertisement data.

It should be noted that the advertisement data is composed of multiple pieces of TS streams, and the TS streams are stored in an order. Therefore, the advertisement data is written into the live file according to the order of storing the TS streams piece by piece, in order to not affect the normal playing of the advertisements.

As can be seen from the above description, in the method for obtaining advertisement data according to the embodiment of the present disclosure, the advertisement data may be obtained in a real time manner from the advertisement server when the live file is played, so that advertisements in the advertising period may be played whenever the live file is played. Compared with the prior art, not only the advertising resources may be fully utilized, but also different contents of advertisements are played when the live file is played at different time, thereby improving user experience.

The technical solution is set forth from the perspective of the client terminal in the above embodiment, and then the technical solution is described from the perspective of the advertisement server below, in order that those skilled in the art may understand the technical solution more completely.

Referring to FIG. 2, it shows a flow chart of a second implementation of a method for obtaining advertisement data according to an embodiment of the present disclosure. The method includes the following steps.

In step S201, request information for obtaining the advertisement data is received.

Based on the description of the above embodiment, the request information for obtaining the advertisement data may include attribute information of a live file and device information of a client terminal, in order that the advertisement server directionally matches the advertisement data.

In step S202, the request information for obtaining the advertisement data is analyzed to obtain matching information of the advertisement data.

After the request information for obtaining advertisement data is received by the advertisement server, performer information, video type information and the like in the attribute information of the live file may be used as matching information, and it is found in the advertisement data in the advertising period whether there is popularized advertisement data associated with the live file. If there is the popularized advertisement data associated with the live file, the found advertisement data is sent to the client terminal.

Optionally, the advertisement server may also generate demographic attribute according to play record information in the device information of the client terminal, and determine the generated demographic attribute as matching information for finding the advertisement data. The demographic attribute includes attribute information such as users' genders, ages and the number of users. The users of different genders and ages generate different play records. Therefore, the demographic attribute of the users may be determined based on the play record information. For example, the users may be determined to be young women of 18 to 25 years old, if most of the play records are Korean dramas.

As can be seen from the description of this step, information of the live file and the client terminal is analyzed by the advertisement server to obtain the matching information of the advertisement data, so that the advertisement data may be directionally matched among the advertisement data in the advertising period, and the advertisement content is customized and personalized for the user, thereby improving the accuracy of directionally matching advertisement and fully utilizing the advertising resources.

In step S203, the advertisement data is determined based on the matching information.

After the matching information is generated by the advertisement server, the matched advertisement data may be determined according to the matching information.

For example, if the live content is the television drama ‘ZhenHuan Biography’, the starring performer information may be used as the matching information, and the popularized advertisement of a television drama ‘Miyue Biography’ with the same starring performers is used as the matched advertisement data. Optionally, after the demographic attribute of the users are determined to be young women of 18 to 25 years old, the advertisement data of cosmetics is used as the matched advertisement data.

In addition, it should be noted that, the obtained request information further includes duration information of advertisements, and the advertisement server may determine a set of advertisement data or generate a list of advertisement data and send the same to the client terminal according to the duration information of advertisements. This may be set according to different requirements and is not limited in the embodiment of the present disclosure.

In the technical solution described in this step, the advertisement data is found by the advertisement server according to the matching information, so that the advertisement content may be customized and personalized for the user, thereby improving the accuracy of directionally matching advertisement, improving user experience and fully utilizing the advertising resources.

In step S204, the advertisement data is sent to a client terminal.

As can be seen from the above embodiments, the live file is in some file format, and in order to facilitate the client terminal to play the advertisement data, the advertisement data sent by the advertisement server may be in the same format as that of the live file. When the file format of the advertisement data is different from that of the live file, format conversion may be performed on the advertisement data before the advertisement data is sent to the client terminal, so as to convert the advertisement data into the same format as that of the live file. The processing of the advertisement data by the client terminal is described in detail in the above embodiments, which is not repeated any more herein.

In view of the above, in the method for obtaining advertisement data according to the embodiment of the present disclosure, a advertisement identification is preset in program data of a live file; if the advertisement identification is read during reading the program data of the live file, request information for obtaining the advertisement data is sent to a advertisement server; and the advertisement data is written to a position indicated by the advertisement identification after the advertisement data sent by the advertisement server is received. Therefore, the advertisement data may be obtained in a real time manner from the advertisement server when the live file is played, and advertisements in the advertising period may be played whenever the live file is played. Compared with the prior art, not only the advertising resources may be fully utilized, but also different contents of advertisements are played when the live file is played at different time, thereby improving user experience.

Corresponding to the above method, an device for obtaining advertisement data is further provided according to an embodiment of the present disclosure. Referring to FIG. 3, it shows a schematic structural diagram of an device for obtaining advertisement data according to an embodiment of the present disclosure. The embodiment is described with respect to a structure of a client terminal.

The device includes a reading module 11, a sending module 12, a receiving module 13, and a writing module 14. The reading module 11 reads program data in a live file. The sending module 12 sends request information for obtaining the advertisement data to an advertisement server, when an advertisement identification preset in the program data is read by the reading module 11. The receiving module 13 receives the advertisement data sent by the advertisement server in response to the request information sent by the sending module 12. The writing module 14 writes the advertisement data received by the receiving module 13 to a position indicated by the advertisement identification in the live file.

Regarding the implementations of functions of the modules in the device, the corresponding implementations in the above described method may be referred to, which are not repeated any more.

It should be noted that, in an embodiment, the writing module 14 includes a determining unit and a writing unit. The determining unit determines an adjacent transport (TS) stream of the advertisement data according to the advertisement identification, wherein the adjacent TS stream is a TS stream before the advertisement data and adjacent to the advertisement data. The writing unit writes a TS stream of the advertisement data piece by piece in a chronological order, after the adjacent TS stream is read.

In an embodiment, on the basis of the above embodiment, the writing module 14 further includes a deleting unit. The determining unit further determines placeholder data preset in the live file according to the advertisement identification. The deleting unit deletes the placeholder data determined by the determining unit, after the placeholder data is read. The writing unit further writes a TS stream of the advertisement data to a position corresponding to the placeholder data piece by piece in a chronological order.

In addition, in another embodiment, the device further includes an obtaining module and a generating module. The obtaining module obtains attribute information of the live file and device information of a client terminal. The generating module generates the request information for obtaining the advertisement data by using the attribute information and the device information as index information of the advertisement data.

Regarding the implementations of functions of the modules and units in the device, the corresponding implementations in the above described method may be referred to, which are not repeated any more.

As can be seen from the above description, in the device for obtaining advertisement data according to the embodiment of the present disclosure, the advertisement data may be obtained in a real time manner from the advertisement server when the live file is played, so that advertisements in the advertising period may be played whenever the live file is played. Compared with the prior art, not only the advertising resources may be fully utilized, but also different contents of advertisements are played when the live file is played at different time, thereby improving user experience.

The device as a client terminal is described in the above embodiment, and an device as an advertisement server is described below, in order that those skilled in the art may understand the technical solution more completely.

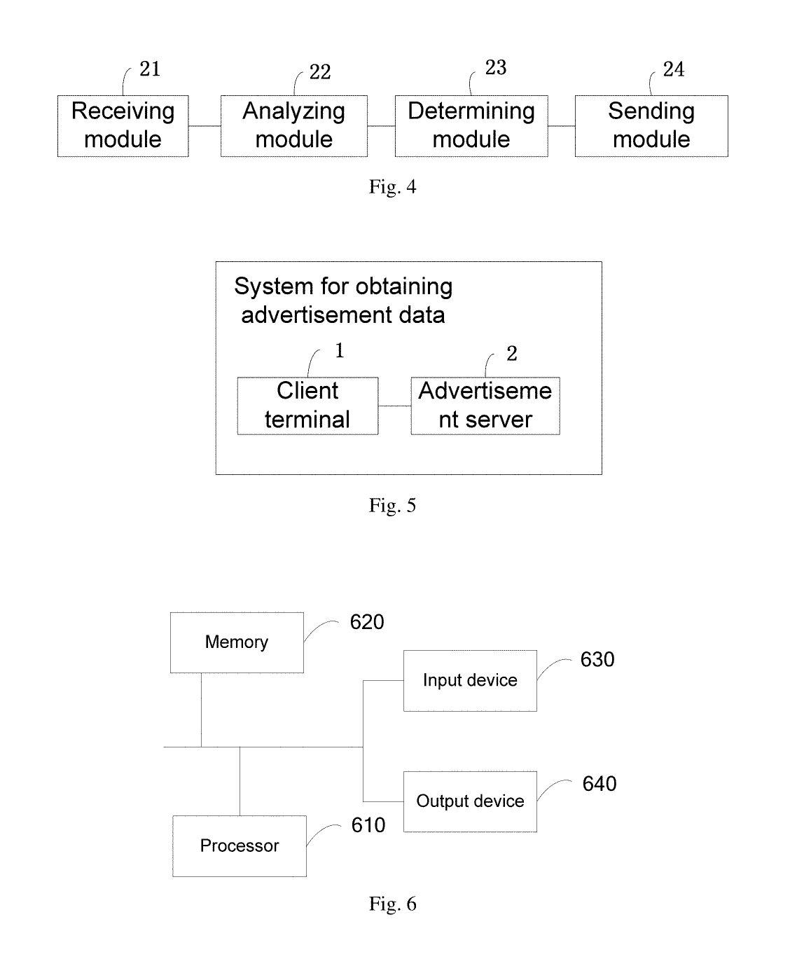

Referring to FIG. 4, it shows a schematic structural diagram of a second implementation of an device for obtaining advertisement data according to an embodiment of the present disclosure. The device includes a receiving module 21, an analyzing module 22, a determining module 23 and a sending module 24. The receiving module 21 receives request information for obtaining the advertisement data. The analyzing module 22 analyzes the request information for obtaining the advertisement data received by the receiving module 21 to obtain matching information of the advertisement data. The determining module 23 determines the advertisement data based on the matching information obtained through analysis of the analyzing module 22. The sending module 24 sends the advertisement data determined by the determining module 23 to a client terminal.

The analyzing module 22 includes a reading unit, a determining unit and a generating unit. In an embodiment, the reading unit reads attribute information of a live file and device information of the client terminal from the request information for obtaining the advertisement data. The determining unit determines performer information in the attribute information to be the matching information.

In another embodiment, the generating unit generates demographic attribute based on play record data in the device information, and further determines the demographic attribute to be the matching information.

Regarding the implementations of functions of the modules and units in the device, the corresponding implementations in the above described method may be referred to, which are not repeated any more.

As can be seen from the above description, in the device for obtaining advertisement data according to the embodiment of the present disclosure, an advertisement identification is preset in program data of a live file; if the advertisement identification is read during reading the program data of the live file, request information for obtaining the advertisement data is sent to an advertisement server; and the advertisement data is written to a position indicated by the advertisement identification after the advertisement data sent by the advertisement server is received. Therefore, the advertisement data may be obtained in a real time manner from the advertisement server when the live file is played, so that advertisements in the advertising period may be played whenever the live file is played. Compared with the prior art, not only the advertising resources may be fully utilized, but also different contents of advertisements are played when the live file is played at different time, thereby improving user experience.

A client terminal is further provided according to an embodiment of the present disclosure, which includes a part or all of modules in the device for obtaining advertisement data according to the embodiment as shown in FIG. 3.

A server is further provided according to an embodiment of the present disclosure, which includes a part or all of modules in the device for obtaining advertisement data according to the embodiment as shown in FIG. 4.

Furthermore, on the basis of the above method and device, a system for obtaining advertisement data is further provided according to an embodiment of the disclosure. Referring to FIG. 5, it shows a schematic structural diagram of a system for obtaining advertisement data according to an embodiment of the present disclosure.

The system includes a client terminal 1 and an advertisement server 2. The client terminal 1 reads program data in a live file; sends request information for obtaining the advertisement data to the advertisement server, when an advertisement identification preset in the program data is read; receives the advertisement data sent by the advertisement server in response to the request information; and writes the advertisement data to a position indicated by the advertisement identification in the live file.

The advertisement server 2 receives the request information for obtaining the advertisement data; analyzes the request information for obtaining the advertisement data to obtain matching information of the advertisement data; determines the advertisement data based on the matching information; and sends the advertisement data to the client terminal.

It should be understood that, the implementations of functions of the client terminal 1 and the advertisement server 2 are described above in details, which are not repeated any more in the embodiment of the present disclosure.

An Embodiment of the present disclosure further provide a non-volatile computer storage medium stored with computer executable instructions, which are used to perform the method for obtaining advertisement data as shown in FIG. 1.

An Embodiment of the present disclosure further provide another non-volatile computer storage medium stored with computer executable instructions, which are used to perform the method for obtaining advertisement data as shown in FIG. 2.

FIG. 6 is a hardware structure diagram of an electronic device for performing a method for obtaining advertisement data according to an embodiment of the present disclosure. As shown in FIG. 6, the device includes one or more processors 610 and a memory 620, and FIG. 6 illustrates one processor 610 as an example.

The device for performing a method for obtaining advertisement data may further include an input device 630 and an output device 640.

The processor 610, memory 620, input device 630 and output device 640 may be connected with each other through bus or other forms of connections. FIG. 6 illustrates bus connection as an example.

As a non-volatile computer readable storage medium, the memory 620 may be configured to store non-volatile software program, non-volatile computer executable program and modules, such as program instructions/modules corresponding to the method for obtaining advertisement data according to the embodiments of the present disclosure (for example, the reading module 11, sending module 12, receiving module 13 and writing module 14 as shown in FIG. 3). By executing the non-volatile software program, instructions and modules stored in the memory 620, the processor 610 may perform various functional applications of a server and data processing, that is, the method for obtaining advertisement data as shown in FIG. 1 according to the above method embodiments.

The memory 620 may include a program storage area and a data storage area, the program storage area may be stored with an operating system and applications which are needed by at least one functions, and the data storage area may be stored with data which is created according to use of the device for obtaining advertisement data. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely from the processor 610, and such memory may be connected with the device for obtaining advertisement data through network connections. The examples of the network connections may include but not limited to internet, intranet, LAN (Local Area Network), mobile communication network or combinations thereof.

The input device 630 may receive inputted digital or character information, and generate key signal input related to the user settings and functional control of the device for obtaining advertisement data. The output device 640 may include a display device such as a display screen.

The above one or more modules may be stored in the memory 620, and when these modules are executed by the one or more processor 610, the method for obtaining advertisement data as shown in FIG. 1according to any one of the above method embodiments may be performed.

The above product may perform the methods provided in the embodiments of the present disclosure, and include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console , E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

In addition, in an embodiment of the present disclosure, the client terminal 1 specifically may be a mobile phone, a tablet computer, an intelligent television or an on-vehicle system and the like, however, which is not intended to be limiting.

In summary, in the method and device for obtaining advertisement data and corresponding system according to the embodiments of the present disclosure, an advertisement identification is preset in program data of a live file; if the advertisement identification is read during reading the program data of the live file, request information for obtaining the advertisement data is sent to an advertisement server; and the advertisement data is written to a position indicated by the advertisement identification after the advertisement data sent by the advertisement server is received. Therefore, the advertisement data may be obtained in a real time manner from the advertisement server when the live file is played, so that advertisements in the advertising period may be played whenever the live file is played. Compared with the prior art, not only the advertising resources may be fully utilized, but also different contents of advertisements are played when the live file is played at different time, thereby improving user experience.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them.

Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for obtaining advertisement data, comprising at an electronic device:
reading program data in a live file;
sending request information for obtaining the advertisement data to an advertisement server, when an advertisement identification preset in the program data is read;
receiving the advertisement data sent by the advertisement server in response to the request information; and
writing the advertisement data to a position indicated by the advertisement identification in the live file.

2. The method according to claim 1, wherein, the writing the advertisement data to a position indicated by the advertisement identification in the live file comprises:
determining an adjacent transport stream, i.e., TS stream, of the advertisement data according to the advertisement identification, wherein, the adjacent TS stream is a TS stream before the advertisement data and adjacent to the advertisement data; and
writing a TS stream of the advertisement data piece by piece in a chronological order, after the adjacent TS stream is read.

3. The method according to claim 1, wherein, the writing the advertisement data to the position indicated by the advertisement identification in the live file comprises:
determining placeholder data preset in the live file according to the advertisement identification;
deleting the placeholder data, after the placeholder data is read; and
writing a TS stream of the advertisement data to a position corresponding to the placeholder data piece by piece in a chronological order.

4. The method according to claim 1, further comprising before the sending the request information for obtaining the advertisement data to the advertisement server:
obtaining attribute information of the live file and device information of a client terminal; and
generating the request information for obtaining the advertisement data by using the attribute information and the device information as index information of the advertisement data.

5. A non-volatile computer-readable storage medium, which is stored with computer executable instructions that, when executed by an electronic device, cause the electronic device to:
read program data in a live file;
send request information for obtaining the advertisement data to an advertisement server, when an advertisement identification preset in the program data is read;
receive the advertisement data sent by the advertisement server in response to the request information; and
write the advertisement data to a position indicated by the advertisement identification in the live file.

6. The non-volatile computer-readable storage medium according to claim 5, wherein, the writing the advertisement data to a position indicated by the advertisement identification in the live file comprises:
determining an adjacent transport stream, i.e., TS stream, of the advertisement data according to the advertisement identification, wherein, the adjacent TS stream is a TS stream before the advertisement data and adjacent to the advertisement data; and
writing a TS stream of the advertisement data piece by piece in a chronological order, after the adjacent TS stream is read.

7. The non-volatile computer-readable storage medium according to claim 5, wherein, the writing the advertisement data to the position indicated by the advertisement identification in the live file comprises:
determining placeholder data preset in the live file according to the advertisement identification;
deleting the placeholder data, after the placeholder data is read; and
writing a TS stream of the advertisement data to a position corresponding to the placeholder data piece by piece in a chronological order.

8. The non-volatile computer-readable storage medium according to claim 5, wherein, the execution of the computer executable instructions further causes the electronic device to, before the sending the request information for obtaining the advertisement data to the advertisement server:
obtain attribute information of the live file and device information of a client terminal; and
generate the request information for obtaining the advertisement data by using the attribute information and the device information as index information of the advertisement data.

9. An electronic device, comprising:
at least one processor; and
a memory, communicably connected with the at least one processor and storing instructions executable by the at least one processor,
wherein execution of the instructions by the at least one processor causes the at least one processor to:
read program data in a live file;
send request information for obtaining the advertisement data to an advertisement server, when an advertisement identification preset in the program data is read;
receive the advertisement data sent by the advertisement server in response to the request information; and
write the advertisement data to a position indicated by the advertisement identification in the live file.

10. The electronic device according to claim 9, wherein, the writing the advertisement data to a position indicated by the advertisement identification in the live file comprises:
determining an adjacent transport stream, i.e., TS stream, of the advertisement data according to the advertisement identification, wherein, the adjacent TS stream is a TS stream before the advertisement data and adjacent to the advertisement data; and
writing a TS stream of the advertisement data piece by piece in a chronological order, after the adjacent TS stream is read.

11. The electronic device according to claim 9, wherein, the writing the advertisement data to the position indicated by the advertisement identification in the live file comprises:
determining placeholder data preset in the live file according to the advertisement identification;
deleting the placeholder data, after the placeholder data is read; and
writing a TS stream of the advertisement data to a position corresponding to the placeholder data piece by piece in a chronological order.

12. The electronic device according to claim 9, wherein, the execution of the instructions by the at least one processor further causes the at least one processor to, before the sending the request information for obtaining the advertisement data to the advertisement server:
obtain attribute information of the live file and device information of a client terminal; and
generate the request information for obtaining the advertisement data by using the attribute information and the device information as index information of the advertisement data.
